(19) United States
(12) Patent Application Publication
(10) Pub. No.: US 2006/0075928 A1
(43) Pub. Date: Apr. 13, 2006

(54) Road surfacing

(75) Inventors: Graeme Richards, Ashby (GB); Paul Phillips, Brailsford (GB)

Correspondence Address: GOODWIN PROCTER LLP;PATENT ADMINISTRATOR, EXCHANGE PLACE, BOSTON, MA, 02109-2881, US

(73) Assignee: Aggregate Industries UK Limited, Ashbourne (GB)

(21) Appl. No.: 10/958,981

(22) Filed: Oct. 5, 2004

(51) Int. Cl. C09D 1/00

(52) U.S. Cl. 106/286.1

(57) ABSTRACT

The use of waste plastic material as a component of asphalt compositions is disclosed.

### FIELD OF THE INVENTION

The present invention relates to a novel asphalt composition suitable for use in the construction of roads.

### DESCRIPTION OF THE PRIOR ART

A considerable amount of polymer waste is produced, both in the United Kingdom and elsewhere, from both domestic and industrial sources. In particular, the automotive industry produces a significant amount of waste polymer products. Examples of polymers present in such polymer waste include but are not limited to polyalkenes such as polyethylene (for example, low density polyethylene, linear low density polyethylene, medium density polyethylene or high density polyethylene) or polypropylene, substituted polyalkenes such as polyvinyl chloride, polyvinylidene chloride, polyvinylidene fluoride, polyvinyl alcohol, polyvinyl formal, polystyrene, expanded polystyrene, poly-(α-methyl) styrene, polyvinyl methyl ether, polyvinyl butyral, poly (vinyl carbazole), poly(chlorotrifluoroethylene), polyvinyl acetate or polytetrafluoroethylene (Teflon®); polyesters such as polyethylene terephthalate (PET), polybutylene terephthalate (PBT); polyamides such as nylon 12 or nylon 6; polyimides; copolymers of the above; and mixtures of the above polymers and copolymers.

Typically, plastics material recovered from a waste stream contains a mixture of the above polymers. Hereinafter this mixed polymer waste product and similar products are referred to as ‘mixed waste plastic’.

An estimate of the proportions by volume of each polymer recovered from European waste polymer streams is as follows:

| | |
|---|---|
| Low density polyethylene(LDPE) | 23% |
| High density polyethylene (HDPE) | 17% |
| Polypropylene | 19% |
| Polystyrene (PS)/Expanded polystyrene (EPS) | 12% |
| Polyvinyl Chloride (PVC) | 11% |
| Polyethylene Terepthalate (PET) | 8% |
| Other plastic types | 10% |

In spite of attempts to increase the direct recycling of polymer waste, most waste plastic is currently disposed of in landfill sites. This not only causes environmental pollution but is increasingly expensive.

Asphalt stabilisation is a remediation technology that has been developed and applied for some considerable time. The process is designed to bind contaminated material in a stable product, reducing risks associated with dermal contact, ingestion and leaching of contaminants to groundwater and surface water. In addition, the process eliminates the need for landfill disposal of contaminated material and associated environmental problems that may arise.

Technology of this type has been used for many years to recycle road planings, reducing the demand for virgin aggregates and recycling the old road surface material. Two methods are used to process materials, hot mix asphalt production and the cold mix method. In these processes an asphalt binder is mixed with soil/stone aggregate and blended to ensure each soil grain and stone aggregate is coated with a thin layer of asphalt. In order to mix the asphalt binder, which is a solid at room temperature, with the aggregate it must be in a liquefied form. Hot mix asphalt production uses heat to liquefy the solid asphalt binder. The cold mix process, also known as Asphalt Emulsion Stabilisation (AES), uses a mixture of water and surfactants to get asphalt into a workable liquid form.

The present applicant's GB-A-2318795 and WO 98/18864 discloses the application of this technology to ash from domestic waste incinerators (bottom ash), and discloses a hot mix asphalt comprising from 10 to 50% by weight of such bottom ash, from 4 to 6% by weight of bitumen having a penetration of from 50 to 200 pen, from 25 to 55% by weight of crushed rock having a particle size of greater than 2 mm, from 10 to 35% by weight of crushed rock fines having a particle size of less than 2 mm and from 0 to 3% by weight of a filler. Preferably, the bottom ash is subjected to electromagnetic and eddy current separation before the mixing process.

Earlier examples of the incorporation of bottom ash in hot mix asphalt compositions are described in GB 1415572 and in Eymael et al., Environmental Aspects of Construction with Waste Materials, 1994, pp. 851-862. EP-A-550303 discloses the incorporation of bottom ash into a cold mix asphalt composition.

The present applicant's GB-A-2331995 and WO 99/29780 disclose the application of this technology to the remediation of contaminated material, particularly land from industrial sites such as coal gasification sites, steel works, coal mines, coking/smelting plants and tar distilling plants. Such land is frequently contaminated with hazardous chemicals such as coal derivatives (particularly polycyclic aromatic hydrocarbons, benzene derivatives, arsenides, sulphides, cyanides, spent oxides), heavy metals and petroleum hydrocarbons. Accordingly, the document discloses a method of remediating said contaminated material, which comprises mixing said contaminated material with a fortification material and filler, cold mixing the resulting mixture with an aqueous cationic bituminous emulsion having a pH of 2 to 5, preferably 3 to 4, and comprising 45 to 70% by weight, preferably 60 to 70% by weight, of bitumen having a penetration of from 15 to 200 pen, preferably 40 to 60 pen, followed by breaking of said emulsion to give a remediated material in which the particles of said contaminated material are coated by a layer of bitumen.

The use of recovered rubber, for example, crushed rubber tyres, in an asphalt composition is also known in the art.

Asphalt stabilisation technology has not, however, previously been successfully applied to the remediation of waste plastic. It would be highly desirable, therefore, to develop a process for the remediation of waste plastic to give a material that exhibits the necessary engineering and environmental properties to enable it to be used in road construction. This would enable the waste plastic to be turned into a product having useful properties and avoid the need to dispose of it in landfill sites. Furthermore, by using waste plastic at least as a partial replacement for virgin aggregate in asphalt compositions, it would be possible to reduce the amount of virgin aggregate required from quarries, thus conferring significant economic and environmental benefits.

It is therefore an object of the present invention to provide a process of remediating waste plastic using asphalt stabilisation technology. It is a further object of the invention to provide a remediated product including waste plastic that is both environmentally stable and suitable for use in the construction of roads.

### SUMMARY OF INVENTION

The present invention therefore provides in a first aspect an asphalt composition suitable for use in the construction of roads, said asphalt composition including a plastics material.

In a second aspect, the invention provides a method of producing an asphalt composition suitable for use in the construction of roads, comprising mixing a plastics material with appropriate amounts of coarse aggregate, fine aggregate, bitumen and, optionally, additives.

In further aspects, the invention provides a road surface formed from the asphalt composition of the invention.

### DETAILED DESCRIPTION OF PREFERRED EMBODIMENTS

In order to form the asphalt composition of the present invention, plastics material is mixed with coarse aggregate, fine aggregate, bitumen and, optionally, additives. The precise amounts of the different components can be varied depending on factors such as the type of plastic, the mixing method (hot or cold mix), the type of road surfacing required (base or wearing course), the prevailing climate in the location in which the road is laid and environmental considerations.

Suitably, the dry portion of the asphalt composition of the present invention may contain:

up to 50% by weight of plastics material and at least 40% by weight of coarse aggregate, relative to the weight of the dry portion of the composition, such that the plastics material and coarse aggregate together comprise 10% to 90% by weight of the dry portion of the composition; and

10% to 90% by weight of fine aggregate, relative to the total weight of the dry portion of the composition, the fine aggregate component optionally including a filler.

By ‘dry portion’ in the context of this specification is meant all the dry ingredients of the asphalt composition (in other words, plastics material, coarse aggregate, fine aggregate, and optionally fillers, fibres etc) other than the bitumen. The proportions by weight of each of the dry components are described as a percentage of the total weight of the dry portion (the ‘total dry weight’). The proportion by weight bitumen is assessed separately, in terms of the parts by weight bitumen (or bituminous emulsion) relative to 100 parts by weight of the dry portion.

The plastics material used in the asphalt composition of the present invention may be any suitable thermoplastic polymer capable of incorporation into an asphalt composition. Examples of plastics materials include but are not limited to polyesters such as polyethylene terephthalate (PET), polybutylene terephthalate (PBT), polyalkenes such as polyethylene (for example, low density polyethylene, linear low density polyethylene, medium density polyethylene or high density polyethylene) or polypropylene, substituted polyalkenes such as polyvinyl chloride, polyvinylidene chloride, polyvinylidene fluoride, polyvinyl alcohol, polyvinyl formal, polystyrene, poly-(α-methyl) styrene, polyvinyl methyl ether, polyvinyl butyral, poly (vinyl carbazole), poly(chlorotrifluoroethylene), polyvinyl acetate or polytetrafluoroethylene (Teflon®; polyamides such as nylon 12 or nylon 6; polyimides; copolymers of the above; and mixtures of the above polymers and copolymers.

Typically, the plastics material used is mixed waste plastic recovered from a waste stream, containing a mixture of polymers.

The plastics material preferably has a density of between 1.0 and 1.5 Mg/M³ as determined according to British Standard Specification (B.S.) 812: Part 2: 1995.

Preferably, the plastics material is supplied in the form of a pre-mixed form including both plastic and aggregate components. The ratio of plastic to aggregate in such a pre-mix composition may vary depending on factors such as the type of plastic, the type of road surfacing required (base or wearing course), the mixing method (hot or cold mixing), the prevailing climate in the location in which the road is laid and environmental considerations. In the present specification, this pre-mix is also referred to as ‘synthetic aggregate’.

The dry portion of the composition preferably contains 1 to 40%, more preferably 2 to 20%, by weight of plastics material.

The coarse aggregate element used in the asphalt composition of the present invention can be any conventionally used in the production of asphalt compositions e.g. limestone, andesite and granite. By ‘coarse’ in the context of this specification is meant that the particle size of the component generally exceeds 2.36 mm, as tested using the appropriate British Standard test sieve. The British Standard test sieve typically used for aggregates in coated materials is that described in BS 63, Part 1. Suitably, about 65% of the coarse aggregate is stopped by the 2.36 mm sieve. It may be obtained from the quarry process of blasting, crushing and screening of a mineral deposit. However, it may also comprise gravel or so-called secondary aggregate obtained from the recovery of used building materials from demolished buildings, old asphalt planings and the like.

The dry portion of the composition preferably contains 40 to 80%, more preferably 50 to 70%, by weight of coarse aggregate relative to the total weight of the dry portion of the composition.

Preferably, the plastics material and coarse aggregate together comprise 50% to 80%, more preferably 60% to 75%, by weight of the total dry portion of the composition.

The fine aggregates used in the asphalt composition of the present invention can be any conventionally used in the production of asphalt compositions. By ‘fine’ in the context of the present specification is meant that the particle size of the component is less than the nominal 2.36 mm, as tested using the appropriate British Standard test sieve. The fine aggregates may, for example, be obtained from the same quarry process as the coarse aggregates. However, ash (for example, fly ash or bottom ash obtained from a domestic waste incinerator, as described in more detail in GB-A-2318795 and WO 98/18864 to which reference is made), sand (for example, natural sand, foundry sand or china clay sand), cement (such as Portland cement), and mixtures thereof may also form the fine aggregates element.

The dry portion of the composition preferably contains 15 to 30%, more preferably 20 to 25%, by weight of fine aggregate relative to the total weight of the dry portion of the composition.

Preferably, the plastics material is supplied in the form of a pre-mixed form including both plastic and aggregate components. Suitably, the pre-mix may contain up to 50% by weight plastic and at least 50% by weight aggregate (the percentages being assessed as a proportion of the total weight of the pre-mix). Preferably, the pre-mix contains from 15 to 45%, more preferably 25 to 35%, by weight plastics material and from 55 to 85%, more preferably 65 to 75%, by weight of aggregate. The aggregate component of the pre-mix is preferably fine aggregate, as described below.

The asphalt composition of the present invention may be formed by either a hot mixing or a cold mixing method, described in more detail below.

In order to form a hot mix asphalt composition, 100 parts by weight of the above dry portion of the composition are mixed with 4 to 7 parts by weight of bitumen in a suitable hot mix asphalt plant. Suitably, the hot mixing process may be carried out at a temperature ranging from 120° C. to 190° C., preferably 140° C. to 170° C., and more preferably 150° C. to 160° C.

When the plastics material is supplied in the form of a pre-mixed form, the dry portion of the hot mix asphalt composition preferably contains from 5% to 50% by weight, more preferably from 8% to 30% by weight, of pre-mix relative to the total weight of the dry portion of the composition.

The bitumen used in the hot mix asphalt composition of the present invention has a penetration of from 50 to 200 pen, preferably 100 to 150 pen as determined according to British Standard Specification (B.S.) 3690 (a test which is based on viscosity ranking test; 1 pen=0.1 mm). Preferably, the hot mix asphalt composition contains from 4.5 to 6.5 parts by weight, more preferably 5 to 6 parts by weight, and even more preferably 5.2 to 5.7 parts by weight of bitumen relative to 100 parts by weight of the dry portion of the composition.

Alternatively, the asphalt composition of the present invention may be formed by a cold mixing method. This involves the mixing of 100 parts by weight of the above dry portion of the composition with 4 to 7 parts by weight of a suitable aqueous cationic bituminous emulsion in a suitable cold mix asphalt plant, and the emulsion is then broken to give a material in which the particles of the dry portion of the composition are coated by a layer of bitumen. Without wishing to be bound by theory, it is believed that the cold mix process may allow a greater proportion of plastics material to be present in the composition, as the process requires little or no heating. In particular, when the plastics material forms a component of a pre-mix as outlined above, the dry portion of the asphalt composition may contain up to 100% by weight of the pre-mix. Preferably, the dry portion of the cold mix asphalt composition contains 20% to 80% by weight of the pre-mix.

Ideally, purpose built cold mix plants, which can carefully control the quantities of the components added and their rate of addition and mixing should be used. One example of a suitable purpose built plant is the Ammann Cold Mix Concept plant which is manufactured by Ammann Limited of Chippenham, Wiltshire, U.K.

Suitably, the aqueous cationic bituminous emulsion used to prepare the cold mix asphalt composition of the present invention has a pH of 2 to 5, preferably 3 to 4, and comprises 45 to 70% by weight, preferably 60 to 70% by weight, of bitumen having a penetration of from 15 to 200 pen, preferably 40 to 60 pen. This ensures stable encapsulation of the dry portion of the asphalt composition. The actual mixing process used, however, is fairly typical of other cold mix asphalt processes known in the art. The emulsion will usually contain an emulsifying agent, the nature of which will vary depending on the desired break time for the emulsion. Regulators are included in the emulsion to strictly control the pH to the required level. Typically the pH regulator is a strong mineral acid, preferably hydrochloric acid.

Before mixing, the emulsion is preferably maintained at a temperature of 5 to 30° C. Mixing of the emulsion with the dry portion is usually performed at ambient temperature. The components are mixed slowly to ensure that the emulsion does not break until the desired time. Breaking of the emulsion to encapsulate the particles of the dry portion is effected by compaction of the mixture of dry portion and emulsion.

The bitumen present in the aqueous cationic bituminous emulsion used to prepare the cold mix asphalt composition of the present invention has a penetration of from 15 to 200 pen, as determined according to British Standard Specification (B.S.) 3690, Part 1 (published in 1989 by the British Standards Institute). The actual viscosity of the bitumen chosen will vary depending upon factors such as the type of plastic, the type of road surfacing required (base or wearing course), the prevailing climate in the location in which the road is laid and environmental considerations. Preferably the bitumen used has a penetration of 40 to 60 pen. In one particular example, the bitumen used has a penetration of 50 pen.

The cold aqueous cationic bituminous emulsion may further comprise light petroleum oils that act to reduce the viscosity of the bitumen. This has the effect of increasing the elasticity of the asphalt composition obtained but it also reduces its load bearing capacity.

The dry portion of the asphalt composition of the present invention may further contain additives such as fillers and cellulosic fibres. Furthermore, the bitumen may be modified with a polymer. The nature of such additives is known in the art and is not the subject of this invention.

When a filler is included in the dry portion of the asphalt composition of the present invention, the fillers used are generally those conventionally used in the production of asphalt compositions. These include powders whose particle size is substantially less than 75 μm as tested by the appropriate British Standard test sieve. Typically 85-100 wt. % of the filler passes a 75 μm BS sieve. Examples of suitable fillers include the finer grades of the fine aggregate components mentioned above, or the product of milling limestone aggregate. Hydration may be improved by the addition of lime, hydrated lime, sulphate resisting cement or ordinary Portland cement as a filler. These powdery fillers can also act to dry materials out by increasing aggregate surface area. The dry portion of the asphalt composition may contain up to 15%, preferably up to 10%, more preferably up to 5%, by weight of filler. This proportion of filler may substitute for the corresponding proportion of the fine aggregate element.

The ease of coating of the dry portion and the ease of working of the thus obtained product may be enhanced by inclusion in the filler element of fibres such as cellulosic fibres. The cellulosic fibres should ideally contain at least 70% by weight of cellulose. Preferably, the proportion of cellulosic fibres in the total mixture is up to 1% by weight, more preferably 0.2 to 0.6% by weight. Pelletised cellulosic fibres may be used. Examples of suitable fibres include Topcel™ and Technocel™ obtainable from Cellulose Fülstoff Fabrik, Fleenwerg, Mönchengladbach, Germany. Typically, the fibres are obtained from recycled paper.

The bitumen may be modified with a polymer chosen from ethylene-vinyl acetate copolymer, styrene-butadiene-styrene block copolymer, styrene-butadiene rubber and natural latex. Modification with these polymers results in an asphalt composition that is both more elastic, making it less prone to cracking in cold weather, and more viscous, making it less likely to soften in hot weather.

The asphalt composition is usually spread either by hand or by use of a mechanical paver/spreader. This is then compacted, typically by means of a steel drum with a vibratory action or by pneumatic tyred rollers. When the material is used as a road base, a thin layer wearing course is applied to the material once compacted.

### EXAMPLE

Using a hot mix asphalt plant at 130-165° C., 5.6 parts by weight of bitumen (100/150 pen grade; available from BP, Llandarcy, UK) was combined with 100 parts by weight of a dry mixture having the following composition:

| Component | Amount | Source |
|---|---|---|
| Synthetic | 10.6 wt. % | 30% mixed polymer waste |
| aggregate | | (Ford Motor Co) and 70% fine aggregate |
| (nominal | | (Cwm Nant Lleici, Wales, UK) |
| particle size | | |
| 14-5 mm) | | |
| China Clay | 7.1 wt. % | Imerys, Cornwall, UK |
| waste | | |
| Coarse | 68.9 wt. % | Bardon Hill Quarry, Leicestershire, UK |
| aggregate | | |
| Fine aggregate | 7.1 wt. % | Bardon Hill Quarry, Leicestershire, UK |
| Filler | 5.3 wt. % | Francis Flowers, Somerset, UK |

After the above components are mixed, 100 parts by weight of the above mixture are then mixed with 0.3 parts by weight of cellulose fibres (obtainable from Cellulose Fülstoff Fabrik, Fleenwerg, Mönchengladbach, Germany) to give an asphalt composition according to the present invention.

Leachate from the synthetic aggregate used in the above example was analysed by CERAM Research Limited, Stoke-on-Trent, UK, according to the procedure set out in Extraction to 'Interim NRA Guidance Research & Development Note 301′, published by the UK National Rivers Authority.

The leachate was found to contain less than 0.5 ppm total petroleum hydrocarbons, as well as metals in the following quantities:

| Metal | Amount present (mg/l) |
|---|---|
| Arsenic (As) | <0.05 |
| Boron (B) | <0.05 |
| Cadmium (Cd) | <0.01 |
| Chromium (Cr) | <0.01 |
| Copper (Cu) | 0.02 |
| Mercury (Hg) | <0.1 |
| Nickel (Ni) | 0.02 |
| Lead (Pb) | <0.02 |
| Selenium (Se) | <0.5 |
| Zinc (Zn) | 0.04 |

1. An asphalt composition suitable for use in the construction of roads, said asphalt composition comprising a plastics material.

2. An asphalt composition according to claim 1, wherein the asphalt composition comprises a dry portion comprising:
up to 50% by weight of plastics material and at least 40% by weight of coarse aggregate, relative to the weight of the dry portion of the composition, such that the plastics material and coarse aggregate together comprise 40% to 90% by weight of the dry portion of the composition; and
10% to 60% by weight of fine aggregate, relative to the total weight of the dry portion of the composition, the fine aggregate component optionally including a filler.

3. An asphalt composition according to claim 2, wherein the dry portion of the asphalt composition comprises 1 to 40% by weight of plastics material.

4. An asphalt composition according to claim 2, wherein the dry portion of the asphalt composition comprises 40 to 80% by weight of coarse aggregate.

5. An asphalt composition according to claim 2, wherein the plastics material and coarse aggregate together comprise 50% to 80% by weight of the dry portion of the composition.

6. An asphalt composition according to claim 2, wherein the dry portion of the asphalt composition comprises 15 to 30% by weight of fine aggregate.

7. An asphalt composition according to claim 1, wherein the plastics material comprises a pre-mixed form comprising plastic and aggregate.

8. An asphalt composition according to claim 7, wherein the pre-mixed form comprises up to 50% by weight plastic and at least 50% by weight aggregate.

9. An asphalt composition according to claim 8, wherein the pre-mixed form comprises from 15 to 45% by weight plastics and from 55 to 85% by weight aggregate.

10. An asphalt composition according to claim 7, wherein the aggregate component of the pre-mixed form comprises fine aggregate.

11. An asphalt composition according to claim 2, wherein the composition is obtained by hot mixing 100 parts by weight of the dry portion with 4 to 7 parts by weight of bitumen.

12. An asphalt composition according to claim 11, comprising from 4.5 to 6.5 parts by weight of bitumen relative to 100 parts by weight of dry portion.

13. An asphalt composition according to claim 2, wherein the composition is obtained by cold mixing 100 parts by weight of dry portion with 4 to 7 parts by weight of a suitable aqueous cationic bituminous emulsion, followed by breaking the emulsion to give a material in which the particles of the dry portion of the composition are coated by a layer of bitumen.

14. An asphalt composition according to claim 13, wherein the aqueous cationic bituminous emulsion comprises a pH of 2 to 5.

15. An asphalt composition according to claim 14, wherein the aqueous cationic bituminous emulsion comprises 45 to 70% by weight of bitumen.

16. A method of producing an asphalt composition suitable for use in the construction of roads, the method comprising:
mixing a dry portion comprising a plastics material, coarse aggregate, and fine aggregate with bitumen and, optionally, additives.

17. A method according to claim 16, comprising hot mixing 100 parts by weight of the dry portion with 4 to 7 parts by weight of bitumen.

18. A method according to claim 17, wherein the hot mixing process is carried out at a temperature ranging from 140° C. to 170° C.

19. A method according to claim 16, comprising cold mixing 100 parts by weight of dry portion with 4 to 7 parts by weight of a suitable aqueous cationic bituminous emulsion, followed by breaking the emulsion to give a material in which the particles of the dry portion of the composition are coated by a layer of bitumen.

20. (canceled)

21. A road surface comprising a plastics material.

22. An asphalt composition according to claim 11, wherein the dry portion is selected from:
a dry portion comprising 1 to 40% by weight of plastics material;
a dry portion comprising 40 to 80% by weight of coarse aggregate;
a dry portion comprising 15 to 30% by weight of fine aggregate;
a dry portion comprising the plastics material and coarse aggregate together comprising 50% to 80% by weight of the dry portion of the composition;
a dry portion comprising a plastics material in a pre-mixed form comprising plastic and aggregate; and
a dry portion comprising a plastics material in a pre-mixed form comprising plastic and aggregate, wherein the pre-mixed form is selected from a pre-mixed form comprising 50% by weight plastic and at least 50% by weight aggregate, a pre-mixed form comprising 15 to 45% by weight plastic and from 55 to 85% by weight aggregate, and a pre-mixed form wherein the aggregate comprises fine aggregate.

23. An asphalt composition according to claim 13, wherein the dry portion is selected from:
a dry portion comprising 1 to 40% by weight of plastics material;
a dry portion comprising 40 to 80% by weight of coarse aggregate;
a dry portion comprising 15 to 30% by weight of fine aggregate;
a dry portion comprising the plastics material and coarse aggregate together comprising 50% to 80% by weight of the dry portion of the composition;
a dry portion comprising a plastics material in a pre-mixed form comprising plastic and aggregate; and
a dry portion comprising a plastics material in a pre-mixed form comprising plastic and aggregate, wherein the pre-mixed form is selected from a pre-mixed form comprising 50% by weight plastic and at least 50% by weight aggregate, a pre-mixed form comprising 15 to 45% by weight plastic and from 55 to 85% by weight aggregate, and a pre-mixed form wherein the aggregate comprises fine aggregate.

24. An asphalt composition according to claim 17, wherein the dry portion is selected from:
a dry portion comprising 1 to 40% by weight of plastics material;
a dry portion comprising 40 to 80% by weight of coarse aggregate;
a dry portion comprising 15 to 30% by weight of fine aggregate;
a dry portion comprising the plastics material and coarse aggregate together comprising 50% to 80% by weight of the dry portion of the composition;
a dry portion comprising a plastics material in a pre-mixed form comprising plastic and aggregate; and
a dry portion comprising a plastics material in a pre-mixed form comprising plastic and aggregate, wherein the pre-mixed form is selected from a pre-mixed form comprising 50% by weight plastic and at least 50% by weight aggregate, a pre-mixed form comprising 15 to 45% by weight plastic and from 55 to 85% by weight aggregate, and a pre-mixed form wherein the aggregate comprises fine aggregate.

25. An asphalt composition according to claim 19, wherein the dry portion is selected from:
a dry portion comprising 1 to 40% by weight of plastics material;
a dry portion comprising 40 to 80% by weight of coarse aggregate;
a dry portion comprising 15 to 30% by weight of fine aggregate; and
a dry portion comprising the plastics material and coarse aggregate together comprising 50% to 80% by weight of the dry portion of the composition.
